(19) United States
(12) Patent Application Publication
(10) Pub. No.: US 2026/0195957 A1
(43) Pub. Date: Jul. 9, 2026

(54) SYSTEM AND A METHOD FOR GENERATIVE HUMAN MOTION STYLE TRANSFER

(71) Applicant: HUAWEI TECHNOLOGIES CO., LTD., Shenzhen (CN)

(72) Inventors: Chuan GUO, Kanata (CA); Xinxin ZUO, Kanata (CA); Matthew MU, Kanata (CA); Peng DAI, Kanata (CA); Juwei LU, Kanata (CA); Youliang YAN, Shenzhen (CN)

(21) Appl. No.: 19/558,660

(22) Filed: Mar. 6, 2026

Related U.S. Application Data
(63) Continuation of application No. PCT/CN2023/117589, filed on Sep. 8, 2023.

(51) Int. Cl. G06T 13/40; G06N 3/0475; G06N 7/01

(52) U.S. Cl. CPC G06T 13/40; G06N 3/0475; G06N 7/01

(57) ABSTRACT

A method and a server for training a generative stylization system to generate motion sequences for digital objects are provided. The method comprises: generating, based on a training motion feature vector representative of a given training motion sequence of a training digital object, a respective training motion content feature vector representative of a content of the given training motion sequence; stochastically generating a respective training motion style feature vector representative of a style of the given training motion sequence; generating, based on the respective training motion content and style feature vectors, a synthetic motion feature vector representative of a synthetic motion sequence; and training the generative stylization system to generate an in-use synthetic motion sequence by minimizing a difference between the training motion feature vector and the synthetic motion feature vector

### CROSS-REFERENCE

The present application is a continuation of International Patent Application No. PCT/CN2023/117589, filed Sep. 8, 2023, entitled “SYSTEM AND METHOD FOR GENERATIVE HUMAN MOTION STYLE TRANSFER”, the entirety of which is incorporated herein by reference.

### FIELD

The present technology relates broadly to the field of animation and, in particular, to a system and a method for applying various motion styles to a given animated object.

### BACKGROUND

Human motion stylization is the process of transferring style information to an input motion of a given animated object without altering content of the input motion.

Natural human body movements may be comparatively expressive and complicated. However, the way a given person moves may be indicative of personality and mood of the given person. For example, the given person can be identified or their mood and/or emotional state can be deduced through the way they walk as there are certain motion traits that are unique to each given person. These distinguishable motion traits, defining a motion style of the given person, have been important elements in the 3D animation industry to study for creating realistic character animation. However, it may be computationally expensive to transfer movements of different styles directly to the animated objects.

There is therefore a desire for more computationally efficient solutions for stylizing animated objects' movements.

Certain prior art approaches have been proposed to tackle the above-identified technical problem.

An article entitled “Realtime Style Transfer for Unlabeled Heterogeneous Human Motion”, authored by Xia S, Wang C, Chai J, et al., and published in ACM Transactions on Graphics (TOG) in the year 2015, discloses real time generation of stylistic human motion that automatically transforms unlabeled, heterogeneous motion data into new styles. More specifically, this article discloses an online learning algorithm that automatically constructs a series of local mixtures of autoregressive models (MAR) to capture the complex relationships between styles of motion.

An article entitled “A Deep Learning System for Character Motion Synthesis and Editing”, authored by Holden D, Saito J, Komura T., and published in ACM Transactions on Graphics (TOG) in the year 2016, discloses a system to synthesize character movements based on high level parameters, such that the produced movements respect the manifold of human motion, trained on a large motion capture dataset. The learned motion manifold, which is represented by the hidden units of a convolutional autoencoder, represents motion data in sparse components which can be combined to produce a wide range of complex movements.

An article entitled “Stylistic Locomotion Modeling and Synthesis Using Variational Generative Models”, authored by Du H, Herrmann E, Sprenger J, et al., and published in Proceedings of the 12th ACM SIGGRAPH Conference on Motion, Interaction and Games in the year 2019, discloses an approach to create generative models for distinctive styles of locomotion for humanoid characters. More specifically, the article discloses a variational generative model combining the large variation in neutral motion database and style information from a limited number of examples.

An article entitled “Unpaired Motion Style Transfer from Video to Animation”, authored by Aberman K, Weng Y, Lischinski D, et al., and published in ACM Transactions on Graphics (TOG) in the year 2020, discloses a data-driven system for motion style transfer, which learns from an unpaired collection of motions with style labels, and enables transferring motion styles not observed during training. Furthermore, the disclosed system is able to extract motion styles directly from videos, bypassing 3D reconstruction, and apply them to the 3D input motion.

### SUMMARY

Developers have devised methods and devices for overcoming at least some drawbacks present in prior art solutions.

Unlike some prior art methods that usually rely on a deterministic mapping from input motion and style signal to target domain, various non-limiting embodiments of the present technology are directed to a generative system that that produces diverse stylization results given a 3D human motion and style signal.

More specifically, the methods and systems described herein are directed to: (1) training an autoencoder to generate, for a given motion sequence of a given animated object, a respective latent motion feature vector; (2) encoding the respective latent motion feature vector to generate content and style feature vectors indicative of a content (such as walking, running, writing, and the like) and style (old, young, drunk, agitated, and the like) of the movement represented by the given motion sequence. Further, the present methods and systems, include swapping content and style feature vector associated with different latent motion feature vectors of respective motion sequences, thereby generating training digital objects, a given one of which includes (i) a given content feature vector associated with a first motion sequence; and (ii) a respective style feature vector.

Further, the present methods include training, using the generated training digital objects, a generator machine-learning (ML) model to generate output latent motion feature vectors indicative of new motion sequences combining the contents and styles represented by the respective input training digital objects.

Thus, by doing so the present methods and system may allow generating longer motion sequences more efficiently (that is, requiring less time) than the prior art approaches.

More specifically, in accordance with a first broad aspect of the present technology, there is provided a computer-implemented method for training a generative stylization system to generate motion sequences for digital objects. The method comprises: generating, using a content encoder of the generative stylization system, based on a training motion feature vector representative of a given training motion sequence of a training digital object, a respective training motion content feature vector representative of a motion content of the given training motion sequence; stochastically generating a respective training motion style feature vector representative of a style of the given training motion sequence. The stochastically generating comprises: generating, using a style encoder of the generative stylization system, based on the training motion feature vector, one or more parameters for a given variant of a given predetermined type of probability distribution; and sampling the respective training motion style feature vector from the given variant of the given predetermined type of probability distribution. The method further comprises: generating, using a generator of the generative stylization system, based on the respective training motion content and style feature vectors, a synthetic motion feature vector representative of a synthetic motion sequence; and training the generative stylization system to generate an in-use synthetic motion sequence by minimizing a difference between the training motion feature vector and the synthetic motion feature vector.

In some implementations of the method, the given predetermined type of probability distribution is a normal distribution; and the one or more parameters include at least a mean and a variance of the normal distribution.

In some implementations of the method, the stochastically generating comprises feeding the training motion feature vector to the style encoder; prior to the stochastically generating the respective training motion style feature vector, the method further comprises receiving a training style label for the given training sequence motion sequence; and the stochastically generating the respective training motion style feature vector further comprises feeding the training style label to the style encoder.

In some implementations of the method, the method further comprises determining, based on the synthetic motion feature vector, the respective synthetic training motion sequence; and the minimizing the difference comprises minimizing a difference between at least one of: (i) the respective motion feature vector and the synthetic motion feature vector; and (ii) the given training motion sequence and the respective synthetic training motion sequence.

In some implementations of the method, the minimizing the difference comprises minimizing a value of a reconstruction loss function, defined by a following equation:

$${ℒ}_{rec} = {\sum }_{i = 1}^{n} ‖ {\hat{z}}^{i} - {z}^{i} ‖ + ‖ {\hat{P}}^{i} - {P}^{i} ‖ ,$$

where zⁱ is the training motion feature vector,
\hat{z}ⁱ is the respective synthetic training motion feature vector at a respective iteration of the training the generator,
Pⁱ is the given training motion sequence; and
\hat{p}ⁱ is the respective synthetic training motion sequence determined based on the synthetic training motion feature vector.

In some implementations of the method, the stochastically generating comprises generating, using the style encoder, based on the training motion feature vector, one or more parameters for a first variant of the given predetermined type of probability distribution; and the training the generative stylization system further comprises: accessing a second style encoder, the second style encoder being a replica of the style encoder, generating, using the second style encoder, based on a second training motion feature vector representative of a second training motion sequence of the training digital object, one or more parameters for a second variant of the given predetermined type of probability distribution, the given training motion sequence and the second training motion sequence being motion subsequences of a single training motion sequence of the training digital object; and minimizing a difference between the first and second variants of the given predetermined type of probability distribution.

In some implementations of the method, the given predetermined type of probability distribution comprises a normal distribution; and the minimizing the difference between the first and second variants of the given predetermined type of probability distribution comprises minimizing a value of a homo-style alignment loss function, defined by a following equation:

$${ℒ}_{hsa} = {D}_{KL} ( {𝒩}_{s}^{1} ( {μ}_{s}^{1} , {σ}_{s}^{1} ) ‖ {𝒩}_{s}^{2} ( {μ}_{s}^{2} , {σ}_{s}^{2} ) ) ,$$

$$where {𝒩}_{s}^{1}$$

is the first variant of the given predetermined type of probability distribution;

$${μ}_{s}^{1}$$

is a mean of the first variant of the given predetermined type of probability distribution;

$${σ}_{s}^{1}$$

is a variance of the first variant of the given predetermined type of probability distribution;

$${𝒩}_{s}^{2}$$

is the second variant of the given predetermined type of probability distribution;

$${μ}_{s}^{2}$$

is the mean of the second variant of the given predetermined type of probability distribution; and

$${σ}_{s}^{2}$$

is the variance of the second variant of the given predetermined type of probability distribution.

In some implementations of the method, prior to the training, the method further comprises: accessing: (i) a second style encoder, and (ii) a second generator, the second style encoder being a replica of the style encoder, and the second generator being a replica of the generator, stochastically generating, using the second style encoder, based on the synthetic motion feature vector, a respective synthetic motion style feature vector representative of the style of the respective synthetic training motion sequence; causing the second generator to generate, based on (1) the respective training motion content feature vector and (2) respective synthetic motion style feature vector, a first intermediate synthetic motion feature vector, and the training further comprises minimizing a first difference between the training motion feature vector and the first intermediate synthetic motion feature vector.

In some implementations of the method, prior to the training, the method further comprises: accessing: (i) a second content encoder, and (ii) a third generator, the second content encoder being a replica of the content encoder; and the third generator being a replica of the generator, generating, using the second content encoder, based on the synthetic motion feature vector, a respective synthetic motion content feature vector representative of the motion content of the respective synthetic training motion sequence; causing the third generator to generate, based on (1) the respective synthetic motion content feature vector and (2) respective training motion style feature vector, a second intermediate synthetic motion feature vector; and the training further comprises minimizing a second difference between the training motion feature vector and the second intermediate synthetic motion feature vector.

In some implementations of the method, prior to the training, the method further comprises: accessing a third style encoder and a fourth style encoder, the third and fourth style encoder being replicas of the style encoder; stochastically generating, using the third style encoder, based on a first training motion feature vector representative of a first training motion sequence of the training digital object, one or more parameters for a first variant of the given predetermined type of probability distribution; stochastically generating, using the fourth style encoder, based on a second training motion feature vector representative of a second training motion sequence of the training digital object, one or more parameters for a second variant of the given predetermined type of probability distribution; the first and second training motion sequences being motion subsequences of an other training motion sequence, different from the given training motion sequence; and the training further comprises minimizing a difference between the first and second variants of the given predetermined type of probability distribution.

In some implementations of the method, the method further comprises: determining, based on the first intermediate synthetic motion feature vector, a first intermediate synthetic training motion sequence; determining, based on the second intermediate synthetic motion feature vector, a second intermediate synthetic training motion sequence; and the minimizing the first difference comprises minimizing a difference between at least one of: (i) the training motion feature vector and the first intermediate synthetic motion feature vector; and (ii) the given motion sequence and the first intermediate synthetic training motion sequence; and the minimizing the second difference comprises minimizing a difference between at least one of: (i) the training motion feature vector and the second intermediate synthetic motion feature vector; and (ii) the given motion sequence and the second intermediate synthetic training motion sequence.

In some implementations of the method, minimizing a given one of the first and second differences comprises minimizing a value of a cycle reconstruction loss function, defined by a following equation:

$${ℒ}_{cyc} = {\sum }_{i = 1}^{n} ‖ {\tilde{z}}^{i} - {z}^{i} ‖ + ‖ {\tilde{P}}^{i} - {P}^{i} ‖ ,$$

where zⁱ is the training motion feature vector,
\hat{z}ⁱ is a respective one of the first and second intermediate synthetic motion feature vectors;
Pⁱ is the given training motion sequence; and
\tilde{P}ⁱ is a respective one of the first and second intermediate synthetic motion sequences.

In some implementations of the method, the stochastically generating the respective training motion style feature vector comprises generating, using the style encoder, based on the training motion feature vector, one or more parameters for a first variant of the given predetermined type of probability distribution; and the stochastically generating the respective synthetic motion style feature vector comprises generating, using the style encoder, based on the synthetic motion feature vector, one or more parameters for a second variant of the given predetermined type of probability distribution; and wherein the training further comprises minimizing a difference between (i) a given one of the first and second variants and (ii) a standard variant of the given probability distribution.

In some implementations of the method, the given predetermined type of probability distribution comprises a normal distribution; and wherein the minimizing the difference between (i) the given one of the first and second variants and (ii) the standard variant of the given probability distribution comprises minimizing a value of a KL loss function, defined by a following equation:

$${ℒ}_{KL} = {\sum }_{i = 1}^{n} {D}_{KL} ( {𝒩}_{s}^{i} ( {μ}_{s}^{i} , {σ}_{s}^{i} ) ‖ 𝒩 ( 0 , 1 ) ) ,$$

$$where {𝒩}_{s}^{i}$$

is the given one of the first and second variant of the given predetermined type of probability distribution;

$${μ}_{s}^{i}$$

is a mean of the given one of the first and second variant of the given predetermined type of probability distribution;

$${σ}_{s}^{i}$$

is a variance of the given one of the first and second variant of the given predetermined type of probability distribution; [symbol] (0, 1) is a standard normal distribution.

In some implementations of the method, the training the generative stylization system comprises jointly training each one of the content encoder, the style encoder, and the generator.

In some implementations of the method, the method further comprises using the trained generative stylization system by: acquiring a reference motion sequence; generating, using the content encoder, based on the reference motion sequence, an in-use motion content feature vector representative of an in-use motion content of an in-use motion sequence; generating, using the style encoder, an in-use motion style feature vector representative of an in-use motion style of the in-use motion sequence; feeding the in-use motion content and style feature vectors to the generator to generate a respective in-use synthetic motion feature vector representative of the in-use motion sequence.

In some implementations of the method, the acquiring the reference motion sequence further comprises acquiring an in-use style label of the in-use motion style; the generating the in-use motion style feature vector further comprises generating the in-use motion style feature vector based on the in-use style label.

In some implementations of the method, the generating the in-use motion style feature vector comprises: generating, using the style encoder, one or more parameters for a respective variant of the given predetermined type of probability distribution; and sampling the in-use motion style feature vector from the respective variant of the given predetermined type of probability distribution.

In some implementations of the method, the sampling comprises randomly sampling.

In some implementations of the method, the training motion feature vector is generated by a pre-trained encoder based on the given training sequence.

Further, in accordance with a second broad aspect of the present technology, there is provided a system for training a generative stylization system to generate motion sequences for digital objects. The system comprises at least one processor and at least one non-transitory computer-readable medium comprising executable instructions, which, when executed by the at least one processor, cause the system to: generate, using a content encoder of the generative stylization system, based on a training motion feature vector representative of a given training motion sequence of a training digital object, a respective training motion content feature vector representative of a motion content of the given training motion sequence; stochastically generate a respective training motion style feature vector representative of a style of the given training motion sequence, by: generating, using a style encoder of the generative stylization system, based on the training motion feature vector, one or more parameters for a given variant of a given predetermined type of probability distribution; and sampling the respective training motion style feature vector from the given variant of the given predetermined type of probability distribution; generate, using a generator of the generative stylization system, based on the respective training motion content and style feature vectors, a synthetic motion feature vector representative of a synthetic motion sequence; and train the generative stylization system to generate an in-use synthetic motion sequence by minimizing a difference between the respective motion feature vector and the synthetic motion feature vector thereby.

In some implementations of the system, the given predetermined type of probability distribution is a normal distribution; and the one or more parameters include at least a mean and a variance of the normal distribution.

In some implementations of the system, to stochastically generate the respective training motion style feature vector, the at least one processor causes the system to feed the training motion feature vector to the style encoder; prior to generating the respective training motion style feature vector, the at least one processor causes the system to receive a training style label for the given training sequence motion sequence; and to generate the respective training motion style feature vector, the at least one processor further causes the system to feed the training style label to the style encoder.

In some implementations of the system, the at least one processor further causes the system to determine, based on the synthetic motion feature vector, the respective synthetic training motion sequence; and to minimize the difference, the at least one processor causes the system to minimize a difference between at least one of: (i) the respective motion feature vector and the synthetic motion feature vector; and (ii) the given training motion sequence and the respective synthetic training motion sequence.

In some implementations of the system, to minimize the difference, the at least one processor causes the system to minimize a value of a reconstruction loss function, defined by a following equation:

$${ℒ}_{rec} = {\sum }_{i = 1}^{n} ‖ {\hat{z}}^{i} - {z}^{i} ‖ + ‖ {\hat{P}}^{i} - {P}^{i} ‖ ,$$

where zⁱ is the training motion feature vector,
\hat{z}ⁱ is the respective synthetic training motion feature vector at a respective iteration of the training the generator;
Pⁱ is the given training motion sequence; and
\hat{P}ⁱ is the respective synthetic training motion sequence determined based on the synthetic training motion feature vector.

In some implementations of the system, to stochastically generate the respective training motion style feature vector, the at least one processor causes the system to generate, using the style encoder, based on the training motion feature vector, one or more parameters for a first variant of the given predetermined type of probability distribution; and wherein to train the generative stylization system, the at least one processor further causes the system to: access a second style encoder, the second style encoder being a replica of the style encoder, stochastically generate, using the second style encoder, based on a second training motion feature vector representative of a second training motion sequence of the training digital object, one or more parameters for a second variant of the given predetermined type of probability distribution, the given training motion sequence and the second training motion sequence being motion subsequences of a single training motion sequence of the training digital object; and minimize a difference between the first and second variants of the given predetermined type of probability distribution.

In some implementations of the system, the given predetermined type of probability distribution comprises a normal distribution; and to minimize the difference between the first and second variants of the given predetermined type of probability distribution, the at least one processor causes the system to minimize a value of a homo-style alignment loss function, defined by a following equation:

$${ℒ}_{hsa} = {D}_{KL} ( {𝒩}_{s}^{1} ( {μ}_{s}^{1} , {σ}_{s}^{1} ) ‖ {𝒩}_{s}^{2} ( {μ}_{s}^{2} , {σ}_{s}^{2} ) ) ,$$

$$where {𝒩}_{s}^{1}$$

is the first variant of the given predetermined type of probability distribution;

$${μ}_{s}^{1}$$

is a mean of the first variant of the given predetermined type of probability distribution;

$${σ}_{s}^{1}$$

is a variance of the first variant of the given predetermined type of probability distribution;

$${𝒩}_{s}^{2}$$

is the second variant of the given predetermined type of probability distribution;

$${μ}_{s}^{2}$$

is the mean of the second variant of the given predetermined type of probability distribution; and

$${σ}_{s}^{2}$$

is the variance of the second variant of the given predetermined type of probability distribution.

In some implementations of the system, prior to training, the at least one processor further causes the system to: access: (i) a second style encoder, and (ii) a second generator, the second style encoder being a replica of the style encoder, and the second generator being a replica of the generator; stochastically generate, using the second style encoder, based on the synthetic motion feature vector, a respective synthetic motion style feature vector representative of the style of the respective synthetic training motion sequence; cause the second generator to generate, based on (1) the respective training motion content feature vector and (2) respective synthetic motion style feature vector, a first intermediate synthetic motion feature vector; and to train the generative stylization system, the at least one processor further causes the system to minimize a first difference between the training motion feature vector and the first intermediate synthetic motion feature vector.

In some implementations of the system, prior to training, the at least one processor further causes the system to: access: (i) a second content encoder, and (ii) a third generator, the second content encoder being a replica of the content encoder; and the third generator being a replica of the generator; generate, using the second content encoder, based on the synthetic motion feature vector, a respective synthetic motion content feature vector representative of the motion content of the respective synthetic training motion sequence; cause the third generator to generate, based on (1) the respective synthetic motion content feature vector and (2) respective training motion style feature vector, a second intermediate synthetic motion feature vector, and wherein to train the generative stylization system, the at least one processor further causes the system to minimize a second difference between the training motion feature vector and the second intermediate synthetic motion feature vector.

In some implementations of the system, prior to training, the at least one processor further causes the system: access a third style encoder and a fourth style encoder, the third and fourth style encoder being replicas of the style encoder; stochastically generate, using the third style encoder, based on a first training motion feature vector representative of a first training motion sequence of the training digital object, one or more parameters for a first variant of the given predetermined type of probability distribution; stochastically generate, using the fourth style encoder, based on a second training motion feature vector representative of a second training motion sequence of the training digital object, one or more parameters for a second variant of the given predetermined type of probability distribution; the first and second training motion sequences being motion subsequences of an other training motion sequence, different from the given training motion sequence; and train the generative stylization system, the at least one processor further causes the system to minimize a difference between the first and second variants of the given predetermined type of probability distribution.

In some implementations of the system, the at least one processor further causes the system to: determine, based on the first intermediate synthetic motion feature vector, a first intermediate synthetic training motion sequence; determine, based on the second intermediate synthetic motion feature vector, a second intermediate synthetic training motion sequence; and to minimize the first difference, the at least one processor further causes the system to minimize a difference between at least one of: (i) the training motion feature vector and the first intermediate synthetic motion feature vector; and (ii) the given motion sequence and the first intermediate synthetic training motion sequence; and to minimize the first difference, the at least one processor further causes the system to minimize a difference between at least one of: (i) the training motion feature vector and the second intermediate synthetic motion feature vector; and (ii) the given motion sequence and the second intermediate synthetic training motion sequence.

In some implementations of the system, to minimize a given one of the first and second differences, the at least one processor further causes the system to minimize a value of a cycle reconstruction loss function, defined by a following equation:

$${ℒ}_{cyc} = {\sum }_{i = 1}^{n} ‖ {\tilde{z}}^{i} - {z}^{i} ‖ + ‖ {\tilde{P}}^{i} - {P}^{i} ‖ ,$$

where zⁱ is the training motion feature vector,
\hat{z}ⁱ is a respective one of the first and second intermediate synthetic motion feature vectors;
Pⁱ is the given training motion sequence; and
\tilde{P}ⁱ is a respective one of the first and second intermediate synthetic motion sequences.

In some implementations of the system, to stochastically generate the respective training motion style feature vector, the at least one processor further causes the system to generate, using the style encoder, based on the training motion feature vector, one or more parameters for a first variant of a given predetermined type of probability distribution; and to generate the respective synthetic motion style feature vector, the at least one processor further causes the system to stochastically generate, using the style encoder, based on the synthetic motion feature vector, one or more parameters for a second variant of the given predetermined type of probability distribution; and to train the generative stylization system, the at least one processor further causes the system to minimize a difference between (i) a given one of the first and second variants and (ii) a standard variant of the given probability distribution.

In some implementations of the system, the given predetermined type of probability distribution comprises a normal distribution; and to minimize the difference between (i) the given one of the first and second variants and (ii) the standard variant of the given probability distribution, the at least one processor further causes the system to minimize a value of a KL loss function, defined by a following equation:

$${ℒ}_{KL} = {\sum }_{i = 1}^{n} {D}_{KL} ( {𝒩}_{s}^{i} ( {μ}_{s}^{i} , {σ}_{s}^{i} ) ‖ 𝒩 ( 0 , 1 ) ) ,$$

$$where {𝒩}_{s}^{i}$$

is the given one of the first and second variant of the given predetermined type of probability distribution;

$${μ}_{s}^{i}$$

is a mean of the given one of the first and second variant of the given predetermined type of probability distribution;

$${σ}_{s}^{i}$$

is a variance of the given one of the first and second variant of the given predetermined type of probability distribution; [symbol] (0, 1) is a standard normal distribution.

In some implementations of the system, to train the generative stylization system, the at least one processor further causes the system to jointly train each one of the content encoder, the style encoder, and the generator.

In some implementations of the system, the at least one processor further causes the system to use the trained generative stylization system by: acquiring a reference motion sequence; generating, using the content encoder, based on the reference motion sequence, an in-use motion content feature vector representative of an in-use motion content of an in-use motion sequence; generating, using the style encoder, an in-use motion style feature vector representative of an in-use motion style of the in-use motion sequence; feeding the in-use motion content and style feature vectors to the generator to generate a respective in-use synthetic motion feature vector representative of the in-use motion sequence.

In some implementations of the system, the acquiring the reference motion sequence further comprises acquiring an in-use style label of the in-use motion style; the generating the in-use motion style feature vector further comprises generating the in-use motion style feature vector based on the in-use style label.

In some implementations of the system, the generating the in-use motion style feature vector comprises: generating, using the style encoder, one or more parameters for a respective variant of the given predetermined type of probability distribution; and sampling the in-use motion style feature vector from the respective variant of the given predetermined type of probability distribution.

In some implementations of the system, the sampling comprises randomly sampling.

In some implementations of the system, to generate the training motion feature vector, the at least one processor causes to: access a pre-trained encoder; and cause the pre-trained encoder to generate the training motion feature vector based on the given training sequence.

In the context of the present specification, a “server” is a computer program that is running on appropriate hardware and is capable of receiving requests (e.g., from devices) over a network, and carrying out those requests, or causing those requests to be carried out. The hardware may be one physical computer or one physical computer system, but neither is required to be the case with respect to the present technology. In the present context, the use of the expression a “server” is not intended to mean that every task (e.g., received instructions or requests) or any particular task will have been received, carried out, or caused to be carried out, by the same server (i.e., the same software and/or hardware); it is intended to mean that any number of software elements or hardware devices may be involved in receiving/sending, carrying out or causing to be carried out any task or request, or the consequences of any task or request; and all of this software and hardware may be one server or multiple servers, both of which are included within the expression “at least one server”.

In the context of the present specification, “device” is any computer hardware that is capable of running software appropriate to the relevant task at hand. Thus, some (non-limiting) examples of devices include personal computers (desktops, laptops, netbooks, etc.), smartphones, and tablets, as well as network equipment such as routers, switches, and gateways. It should be noted that a device acting as a device in the present context is not precluded from acting as a server to other devices. The use of the expression “a device” does not preclude multiple devices being used in receiving/sending, carrying out or causing to be carried out any task or request, or the consequences of any task or request, or steps of any method described herein.

In the context of the present specification, a “database” is any structured collection of data, irrespective of its particular structure, the database management software, or the computer hardware on which the data is stored, implemented or otherwise rendered available for use. A database may reside on the same hardware as the process that stores or makes use of the information stored in the database or it may reside on separate hardware, such as a dedicated server or plurality of servers. It can be said that a database is a logically ordered collection of structured data kept electronically in a computer system

In the context of the present specification, the expression “information” includes information of any nature or kind whatsoever capable of being stored in a database. Thus information includes, but is not limited to audiovisual works (images, movies, sound records, presentations etc.), data (location data, numerical data, etc.), text (opinions, comments, questions, messages, etc.), documents, spreadsheets, lists of words, etc.

In the context of the present specification, the expression “component” is meant to include software (appropriate to a particular hardware context) that is both necessary and sufficient to achieve the specific function(s) being referenced.

In the context of the present specification, the expression “computer usable information storage medium” is intended to include media of any nature and kind whatsoever, including RAM, ROM, disks (CD-ROMs, DVDs, floppy disks, hard drivers, etc.), USB keys, solid state-drives, tape drives, etc.

In the context of the present specification, the words “first”, “second”, “third”, etc. have been used as adjectives only for the purpose of allowing for distinction between the nouns that they modify from one another, and not for the purpose of describing any particular relationship between those nouns. Thus, for example, it should be understood that, the use of the terms “first server” and “third server” is not intended to imply any particular order, type, chronology, hierarchy or ranking (for example) of/between the server, nor is their use (by itself) intended imply that any “second server” must necessarily exist in any given situation. Further, as is discussed herein in other contexts, reference to a “first” element and a “second” element does not preclude the two elements from being the same actual real-world element. Thus, for example, in some instances, a “first” server and a “second” server may be the same software and/or hardware, in other cases they may be different software and/or hardware.

Implementations of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 illustrates an example of a computing device that may be used to implement any of the methods described herein;

FIG. 2 shows a schematic diagram of a generative stylization system, in accordance with certain non-limiting embodiments of the present technology;

FIG. 3 shows a schematic diagram of a training phase of the generative stylization system of FIG. 2, in accordance with certain non-limiting embodiments of the present technology;

FIGS. 4A to 4B shows schematically depicted diagrams of an in-use phase for the embodiments where the generative stylization system of FIG. 2 has been trained in a supervised manner, in accordance with certain non-limiting embodiments of the present technology;

FIGS. 5A to 5B shows schematically depicted diagrams of the in-use phase for the embodiments where the generative stylization system of FIG. 2 has been trained in an unsupervised manner, in accordance with certain non-limiting embodiments of the present technology;

FIG. 6 shows a flowchart diagram of a method for training the generative stylization system of FIG. 2 to generate motion sequences for animating digital objects, in accordance with certain non-limiting embodiments of the present technology;

FIG. 7 shows a table reflective of quantitative results on generating synthetic motion sequences by various generative stylization systems, including the generative stylization system of FIG. 2, trained on different training datasets, in accordance with certain non-limiting embodiments of the present technology;

FIG. 8 shows a table reflective of quantitative results on generating the synthetic motion sequences by various generative stylization systems, including the generative stylization system of FIG. 2, trained on a given training dataset, in accordance with certain non-limiting embodiments of the present technology;

FIG. 9A shows a table including human evaluations of the synthetic motion sequences generated by various generative stylization systems, including the generative stylization system of FIG. 2, in accordance with certain non-limiting embodiments of the present technology;

FIG. 9B shows a table including runtime durations of various generative stylization systems, including the generative stylization system of FIG. 2, in accordance with certain non-limiting embodiments of the present technology;

FIG. 10 shows a schematic diagram of qualitative comparisons of motion sequences generated by various generative stylization systems trained on different training dataset, in accordance with certain non-limiting embodiments of the present technology;

FIG. 11 shows a schematic diagram of in-use motion sequences generated by the generative stylization system of FIG. 2 with and without style label, in accordance with certain non-limiting embodiments of the present technology; and

FIG. 12 shows a schematic diagram of using the generative stylization system of FIG. 2 in a concert with a text-to-motion system, in accordance with certain non-limiting embodiments of the present technology.

### DETAILED DESCRIPTION

The examples and conditional language recited herein are principally intended to aid the reader in understanding the principles of the present technology and not to limit its scope to such specifically recited examples and conditions. It will be appreciated that those skilled in the art may devise various arrangements which, although not explicitly described or shown herein, nonetheless embody the principles of the present technology and are included within its spirit and scope.

Furthermore, as an aid to understanding, the following description may describe relatively simplified implementations of the present technology. As persons skilled in the art would understand, various implementations of the present technology may be of a greater complexity.

In some cases, what are believed to be helpful examples of modifications to the present technology may also be set forth. This is done merely as an aid to understanding, and, again, not to define the scope or set forth the bounds of the present technology. These modifications are not an exhaustive list, and a person skilled in the art may make other modifications while nonetheless remaining within the scope of the present technology. Further, where no examples of modifications have been set forth, it should not be interpreted that no modifications are possible and/or that what is described is the sole manner of implementing that element of the present technology.

Moreover, all statements herein reciting principles, aspects, and implementations of the present technology, as well as specific examples thereof, are intended to encompass both structural and functional equivalents thereof, whether they are currently known or developed in the future. Thus, for example, it will be appreciated by those skilled in the art that any block diagrams herein represent conceptual views of illustrative circuitry embodying the principles of the present technology. Similarly, it will be appreciated that any flowcharts, flow diagrams, state transition diagrams, pseudo-code, and the like represent various processes which may be substantially represented in computer-readable media and so executed by a computer or processor, whether or not such computer or processor is explicitly shown.

The functions of the various elements shown in the figures, including any functional block labeled as a “processor”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. In some embodiments of the present technology, the processor may be a general-purpose processor, such as a central processing unit (CPU) or a processor dedicated to a specific purpose, such as a digital signal processor (DSP). Moreover, explicit use of the term a “processor” should not be construed to refer exclusively to hardware capable of executing software, and may implicitly include, without limitation, application specific integrated circuit (ASIC), field programmable gate array (FPGA), read-only memory (ROM) for storing software, random access memory (RAM), and non-volatile storage. Other hardware, conventional and/or custom, may also be included.

Software modules, or simply modules which are implied to be software, may be represented herein as any combination of flowchart elements or other elements indicating performance of process steps and/or textual description. Such modules may be executed by hardware that is expressly or implicitly shown. Moreover, it should be understood that module may include for example, but without being limitative, computer program logic, computer program instructions, software, stack, firmware, hardware circuitry or a combination thereof which provides the required capabilities.

With these fundamentals in place, we will now consider some non-limiting examples to illustrate various implementations of aspects of the present technology.

### Computing Environment

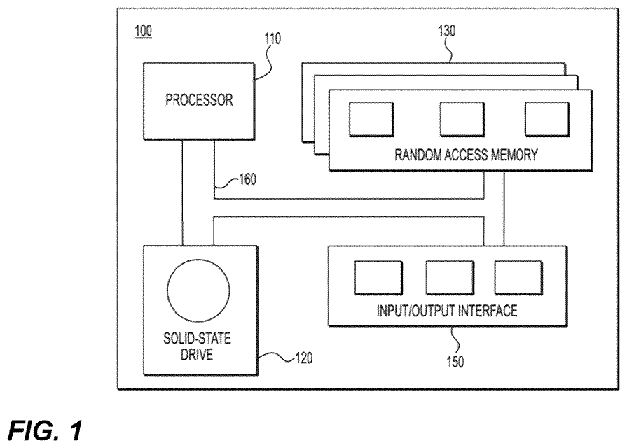

With reference to FIG. 1, there is schematically depicted a diagram of a computing environment 100 in accordance with certain non-limiting embodiments of the present technology. In some embodiments, the computing environment 100 may be implemented by any of a conventional personal computer, a computer dedicated to operating and/or monitoring systems relating to a data center, a controller and/or an electronic device (such as, but not limited to, a mobile device, a tablet device, a server, a controller unit, a control device, a monitoring device etc.) and/or any combination thereof appropriate to the relevant task at hand. In some embodiments, the computing environment 100 comprises various hardware components including one or more single or multi-core processors collectively represented by a processor 110, a solid-state drive 120, a random-access memory 130 and an input/output interface 150.

In some embodiments, the computing environment 100 may also be a sub-system of one of the above-listed systems. In some other embodiments, the computing environment 100 may be an “off the shelf” generic computer system. In some embodiments, the computing environment 100 may also be distributed amongst multiple systems. The computing environment 100 may also be specifically dedicated to the implementation of the present technology. As a person in the art of the present technology may appreciate, multiple variations as to how the computing environment 100 is implemented may be envisioned without departing from the scope of the present technology.

Communication between the various components of the computing environment 100 may be enabled by one or more internal and/or external buses 160 (e.g., a PCI bus, universal serial bus, IEEE 1394 “Firewire” bus, SCSI bus, Serial-ATA bus, ARINC bus, etc.), to which the various hardware components are electronically coupled.

The input/output interface 150 may allow enabling networking capabilities such as wire or wireless access. As an example, the input/output interface 150 may comprise a networking interface such as, but not limited to, a network port, a network socket, a network interface controller and the like. Multiple examples of how the networking interface may be implemented will become apparent to the person skilled in the art of the present technology. For example, but without being limitative, the networking interface may implement specific physical layer and data link layer standard such as Ethernet, Fibre Channel, Wi-Fi or Token Ring. The specific physical layer and the data link layer may provide a base for a full network protocol stack, allowing communication among small groups of computers on the same local area network (LAN) and large-scale network communications through routable protocols, such as Internet Protocol (IP).

According to implementations of the present technology, the solid-state drive 120 stores program instructions suitable for being loaded into the random-access memory 130 and executed by the processor 110 for executing operating data centers based on a generated machine learning pipeline. For example, the program instructions may be part of a library or an application.

In some embodiments of the present technology, the computing environment 100 may be implemented as part of a cloud computing environment. Broadly, a cloud computing environment is a type of computing that relies on a network of remote servers hosted on the internet, for example, to store, manage, and process data, rather than a local server or personal computer. This type of computing allows users to access data and applications from remote locations, and provides a scalable, flexible, and cost-effective solution for data storage and computing. Cloud computing environments can be divided into three main categories: Infrastructure as a Service (IaaS), Platform as a Service (PaaS), and Software as a Service (SaaS). In an IaaS environment, users can rent virtual servers, storage, and other computing resources from a third-party provider, for example. In a PaaS environment, users have access to a platform for developing, running, and managing applications without having to manage the underlying infrastructure. In a SaaS environment, users can access pre-built software applications that are hosted by a third-party provider, for example. In summary, cloud computing environments offer a range of benefits, including cost savings, scalability, increased agility, and the ability to quickly deploy and manage applications.

### Generative Stylization System

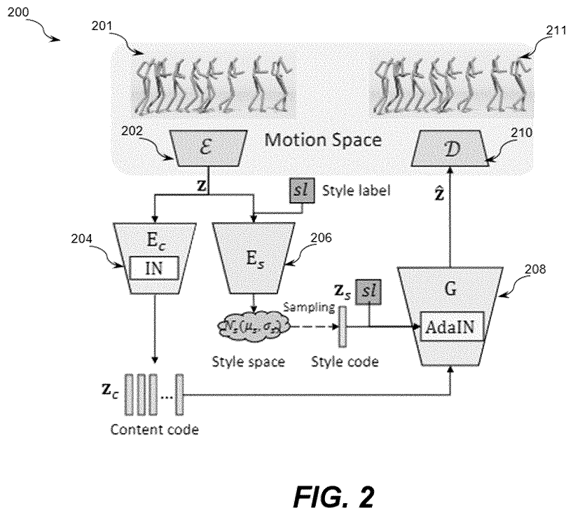

With reference to FIG. 2, there is depicted a schematic diagram of a generative stylization system 200, in accordance with certain non-limiting embodiments of the present technology. Broadly speaking, according to certain non-limiting embodiments of the present technology, the generative stylization system 200 is trained to determine and further apply various motion styles to input motions of animated digital objects. According to certain non-limiting embodiments of the present technology, the generative stylization system 200 can be run by the processor 110 of the computing environment 100.

According to certain non-limiting embodiments of the present technology, a given motion sequence (such as a given motion sequence 201 schematically depicted in FIG. 2) of the given animated object is represented by: (i) a motion content, such as, without limitation, walking, running, jumping, riding a bike, and the like; and (ii) a motion style characterising the given motion content indicating either a human-specific feature thereof, such as age or occupation, or an emotional state thereof. Thus, in some non-limiting embodiments of the present technology, the motion style of the given motion content can include: “young”, “old”, “joyful”, “depressed”, “agitated”, “anxious”, and the like. Thus, as will be explained in detail below, given a motion content of the given digital object and style clues (provided, for example, from the user of the generative stylization system 200) such as a motion style or a respective style label sl∈{1, . . . , N}, where N denotes the number of styles, the generative stylization system 200 can be configured to synthesize a new motion sequence which exhibits the same action semantics as in the motion content, however conveying the style provided by style clues.

According to certain non-limiting embodiments of the present technology, the generative stylization system 200 comprises: (i) an encoder 202 that is configured to generate a respective motion feature vector z of the given motion sequence 201 of the given digital object, that is, to determine an embedding of the given motion sequence 201 into a motion space; (ii) a content encoder 204 configured to generate, based on the respective motion feature vector, a respective motion content feature vector z_{c} (also referred to herein as “content code”) indicative of the motion content of the given motion sequence 201; (iii) a style encoder 206 configured to generate, based on the respective motion feature vector, a respective motion style feature vector zₛ (also referred to herein as “style code”) indicative of the motion style of the given motion sequence 201; (iv) a generator 208 configured to generate, based on the respective motion content and style feature vector, a respective synthetic motion feature vector \hat{z} representative of a new synthetic motion sequence 211 for the given animated object; and (iv) a decoder 210 configured to reconstruct, from the respective synthetic motion feature vector, the new synthetic motion sequence 211.

How each of these components of the generative stylization system 200 is implemented, trained, and used, in accordance with certain non-limiting embodiments of the present technology, will now be described.

### Motion Latent Representation

Before proceeding to the training phase of the generative stylization system 200, in some non-limiting embodiments of the present technology, the processor 110 can be configured to train a motion autoencoder, comprising the encoder 202 and the decoder 210, to build the mapping between raw motions (such as the given motion sequence 201) and deep latent features thereof (such as the respective motion feature vector z). More specifically, given a pose sequence P∈ [symbol] of the given motion sequence 201 in the motion space, where T denotes a number of poses and D denotes a pose dimension, the processor 110 is configured to train the encoder 202 to encode P into the respective motion feature vector z=E(P)∈ [symbol] , with T_{z} and D_{z} being a temporal length and a spatial dimension, respectively. At the same time, the processor 110 is configured to train the decoder 210 to recover the given motion sequence 201 input to the encoder 202 from the respective motion feature vector z, which can be formally expressed as \hat{P}=D(z)=D(E(P)).

In some non-limiting embodiments of the present technology, the encoder 202 and the decoder 210 can be implemented as 1D convolution layers with downsampling and upsampling scale of 4 (that is, T=4Tz), resulting in a more compact form of data that captures temporal semantic information. However, it should be noted that use of other machine-learning model architectures, including various artificial neural networks, for implementing the encoder 202 and the decoder 210 are also envisioned without departing from the scope of the present technology.

Further, it is not limited which training data the processor 110 can be configured to access (or otherwise receive) for training the encoder 202 and the decoder 210. For example, the processor 110 can be configured to receive the training data including various training motion sequences of various animated objects from various types of digital media content, including, without limitation video films, animated films (such as cartoons), video games, virtual reality video content, and the like. Also, a length of the given motion sequence 201 is not limited, and can include, for example, tens, hundreds, or even thousands of poses P of the given digital object.

Thus, to train the encoder 202 and the decoder 210, in some non-limiting embodiments of the present technology, the processor 110 can be configured to: (i) feed training motion sequences to the encoder 202 to generate respective training motion feature vectors defining a given latent feature space; (ii) and regularize the given latent feature space such that it is smooth and has a comparatively low variance. To that end, in some non-limiting embodiments of the present technology, the processor 110 can be configured to apply a light KL regularization towards a standard normal distribution

$${ℒ}_{kld}^{l} = {λ}_{kld}^{l} {D}_{KL} ( z ‖ 𝒩 ( 0 , I ) ) ,$$

where D_{KL}(z∥ [symbol] (0,1)) is a value of KL divergence between the distribution of z and a standard normal probability distribution, and

$${λ}_{kld}^{l}$$

is a hyperparameter, as described, for example, in an article entitled “Auto-Encoding Variational Bayes”, authored by Kingma et al. and published in December 2013.

However, in other non-limiting embodiments of the present technology, the processor 110 can be configured to train a classical autoencoder by applying an L1 regularization on a magnitude and smoothness of each latent feature in the given latent feature space, which can formally be expressed as follows:

$${ℒ}_{reg}^{l} = {λ}_{l 1} {‖ z ‖}_{1} + {λ}_{sms} {‖ {z}_{1 : Tz} - {z}_{0 : Tz - 1} ‖}_{1} ,$$

where z_{1:Tz} and z_{0:Tz-1} are a given and preceding latent feature vectors in the given latent feature space, and λ_{I1}, λₛₘₛ are hyperparameters (can be, for example, 0.001).

### Model Architecture

With continued reference to FIG. 2, according to certain non-limiting embodiments of the present technology, the generative stylization system 200 can be considered as a hybrid variational autoencoder. As mentioned above, the generative stylization system 200 comprises: (i) the content encoder 204, E_{c}, (ii) the style encoder 206, Eₛ, and the generator 208, G. The content encoder 204 is configured to convert the respective motion feature vector z∈ [symbol] into the content code z_{c}∈

$${ℝ}^{{T}_{z}^{c} \times {D}_{z}^{c}}$$

that keeps a temporal dimension

$${T}_{z}^{c} ,$$

where global statistic features (style) are erased through instance normalization (IN).

According to certain non-limiting embodiments of the present technology, the style encoder 206, Eₛ, is configured to generate, based on the respective motion feature vector z (and, in some non-limiting embodiments of the present technology, along with a respective style label sl), a probability distribution vector, such as a normal probability distribution vector [symbol] (μₛ, σₛ), defining the style space, from which the processor 110 can be configured to sample the style code zₛ∈

$${ℝ}^{{D}_{z}^{c}} .$$

It should be noted that for a given motion feature vector, the processor 110 can be configured to sample, from a given probability distribution determined by the style encoder 206, a plurality of different style codes, from which the processor 110 can further select (for example, randomly) a single style code representative of motion style associated with the given motion feature vector.

By doing so, the processor 110 can be configured to generate the style code stochastically, which distinguishes the present methods from the prior art approaches where the style code is generated in a deterministic manner. Broadly speaking, the content code can be said to capture local semantics of the given motion sequence 201 while the style code encodes global features. Further, the processor 110 can be configured to feed the content code Ze to the generator 208, G (which can be implemented based on a convolutional neural network, for example), where the mean and variance of each output layer are modified by an affine transformation of style information (that is, the style code and the respective style label), by applying, for example, an adaptive instance normalization (AdaIN). The generator 208 is trained to generate the respective synthetic motion feature vector based on the content and style codes of the given motion sequence 201. Further, using the decoder 210, the processor 110 can be configured to restore, from the respective synthetic motion feature vector, a respective synthetic motion sequence for the given digital object.

Now, the training phase of the generative stylization system 200 will be described.

### Training Phase

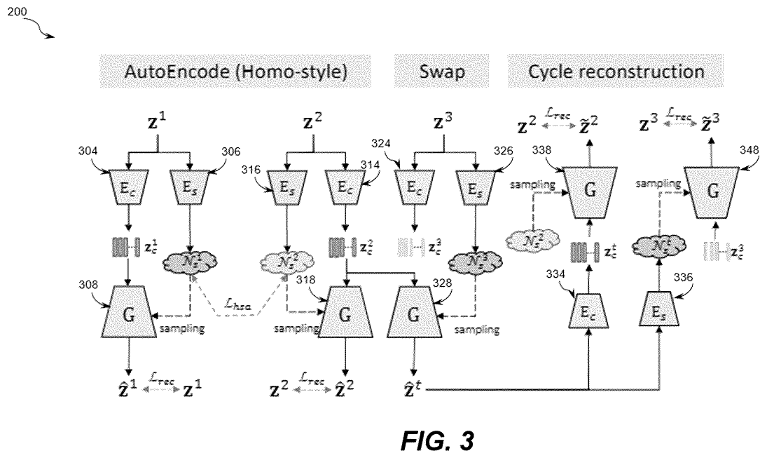

With reference to FIG. 3, there is depicted a schematic diagram of the training phase of the generative stylization system 200, in accordance with certain non-limiting embodiments of the present technology. As mentioned hereinabove, the training data for training the generative stylization system 200 includes motion feature vectors of various training motion sequences. The processor 110 can be configured to generate the motion feature vectors using the encoder 202, pre-trained as described above, based on the respective training motion sequences. In some non-limiting embodiments of the present technology, for each motion feature vector, the training data can include the respective style label sl (which is omitted in FIG. 3 for clarity). It is not limited how the respective style label can be obtained; and in some non-limiting embodiments of the present technology, the respective style label can be assigned to each of the training motion sequences by a human assessor, for example, via an online crowdsourcing platform (such as an Amazon™ Mechanical Turk™ online crowdsourcing platform).

However, it should be expressly understood that the embodiments where the respective style labels are omitted in the training data are also envisioned without departing from the scope of the present technology.

Thus, when training the generative stylization system 200 with the style labels, since both the style encoder 206, Eₛ, and the generator 208, G, are conditioned on the style labels, the so learned style space is encouraged to learn style variables that are label-invariant, aside from the style labels themselves. On the other hand, in an unsupervised setting (that is, without including the style labels to the training data), the generative stylization system 200 is agnostic to the style labels.

In some non-limiting embodiments of the present technology, at a given training iteration, the processor 110 can be configured to feed to the generative stylization system 200 with a respective set of motion feature vectors, including: (i) a first motion feature vector z¹, (ii) a second motion feature vector z², and (iii) a third motion feature vector z³. In some non-limiting embodiments of the present technology, the first and second motion feature vectors z¹, z² can be representative of subsequences of the given training motion sequence (having the same motion content and motion style) while the third motion feature vector z³ can be representative of an other training motion sequence, having at least one of a different motion content and a different motion style than those of the given training motion sequence.

First, according to certain non-limiting embodiments of the present technology, the processor 110 can be configured to train the generative stylization system 200 through autoencoding. More specifically, during this stage of the training phase, the processor 110 can be configured to train the generative stylization system 200 to reconstruct motion feature vectors based on the respective content and style codes. To that end, the processor 110 can be configured to: (i) generate, using a first content encoder 304, based on the first motion feature vector, a first content code; (ii) generate, using a first style encoder 306, based on the first motion feature vector, a first style code; and (iii) feed the first content code and the first style code to a first generator 308, thereby causing the first generator 308 to generate a first synthetic motion feature vector z¹. According to certain non-limiting embodiments of the present technology, the first content encoder 304, the first style encoder 306, and the first generator 308 can be implemented similarly to the content encoder 204, the style encoder 206, and the generator 208 described above.

Further, the processor 110 can be configured to access a second content encoder 314, a second style encoder 316, and a second generator 318, that can be respective replicas of the first content encoder 304, the first style encoder 306, and the first generator 308. Similarly, the processor 110 can be configured to train the second generator 318 to reconstruct the input motion feature vectors by: (i) generating, using the second content encoder 314, based on the second motion feature vector, a second content code; (ii) generating, using the second style encoder 316, based on the second motion feature vector, a second style code; and (iii) feeding the second content code and the second style code to the second generator 318, thereby causing the second generator 318 to generate a second synthetic motion feature vector \hat{z}².

As mentioned hereinabove, in some non-limiting embodiments of the present technology, the processor 110 can be configured to generate a given one of the first style code and the second style code stochastically, by sampling them from respective probability distributions. More specifically, according to certain non-limiting embodiments of the present technology, to generate a give style code, such as the first style code using the first style encoder 306, the processor 110 can be configured to: (i) cause the first style encoder 306 to determine, based on the first motion feature vector, one or more parameters of a given predetermined type of probability distribution; (ii) generate, based on the one or more parameters, a first variant of the given predetermined type of probability distribution; and (iii) sample the first style code from the first variant of the given predetermined type of probability distribution.

In the context of the present specification, the term “given type of probability distribution” denotes a probability distribution defined by a specific probability function. Further, in the context of the present specification, the term “parameters” of the given type of probability distribution denote parameters of the corresponding probability function. Thus, in some non-limiting embodiments of the present technology, the given predetermined type of probability distribution can be a normal probability distribution with the one or more′ parameters thereof being a mean and a variance of the normal probability distribution. Use of other probability distributions, such as a binominal distribution, a Poisson distribution, or a uniform distribution is also envisioned.

In some non-limiting embodiments of the present technology, the processor 110 can be configured to sample the a given style code from the respective variant of the given predetermined type of probability distribution using a reparameterization trick. More specifically, in these embodiments, in case where the given predetermined type of probability distribution is the normal probability distribution, the processor 110 can be configured to: (i) sample noise from the standard normal probability distribution [symbol] (0,1), and (ii) adjust mean value and variance of this noise to the respective values of the mean and variance determined by the respective style encoder.

Formally, this stage of the training phase can be expressed by the following equation \hat{z}ⁱ=G(E_{c}(zⁱ), Eₛ(zⁱ)). Thus, in doing so, the processor 110 can be configured to cause the generative stylization system 200 to generate synthetic motion feature vectors that are representative of respective synthetic motion sequences.

Further, to train the generative stylization system 200 to reconstruct the input motion sequence vectors, the processor 110 can be configured to minimize a difference between a given motion feature vector and a respective synthetic motion feature vector. In some non-limiting embodiments of the present technology, the processor 110 can be configured to determine, using the decoder 210 (not depicted in FIG. 3), based on the first and second synthetic motion feature vectors \hat{z}ⁱ and \hat{z}², a respective one of a first and second synthetic motion sequence \hat{P}¹ and \hat{P}². Further, to train the generative stylization system 200, the processor 110 can be configured to minimize a reconstruction loss function, which, in some non-limiting embodiments of the present technology, is expressed as follows:

$${ℒ}_{rec} = {\sum }_{i = 1}^{n} ‖ {\hat{z}}^{i} - {z}^{i} ‖ + ‖ {\hat{P}}^{i} - {P}^{i} ‖ , \qquad ( 1 )$$

where zⁱ is the given motion feature vector, such as one of the first and second motion feature vectors;
\hat{z}ⁱ is the respective synthetic motion feature vector at the given iteration of the training the generator,
Pⁱ is the given training motion sequence, corresponding to the one of the first and second motion feature vectors; and
\hat{P}ⁱ is the respective synthetic motion sequence determined based on the respective synthetic motion feature vector.

As in some non-limiting embodiments of the present technology the first and second motion feature vectors z¹ and z² are representative of motion subsequences of the given training motion sequence, they are considered to have the same motion style. Thus, to further train the generative stylization system 200 to generate synthetic motion sequences, in some non-limiting embodiments of the present technology, the processor 110 can be configured to force the respective variants of the given predetermined type of probability distribution, from which the first and second style codes have been sampled, to be close. To do so, in some non-limiting embodiments of the present technology, the processor 110 can be configured to minimize a homo-style alignment loss function, defined by a following equation:

$${ℒ}_{hsa} = {D}_{KL} ( {𝒩}_{s}^{1} ( {μ}_{s}^{1} , {σ}_{s}^{1} ) ‖ {𝒩}_{s}^{2} ( {μ}_{s}^{2} , {σ}_{s}^{2} ) ) , \qquad ( 2 )$$

$$where {𝒩}_{s}^{1}$$

is the first variant of the given predetermined type of probability distribution, associated with the first style code;

$${μ}_{s}^{1}$$

is a mean of the first variant of the given predetermined type of probability distribution;

$${σ}_{s}^{1}$$

is a mean of the first variant of the given predetermined type of probability distribution;

$${𝒩}_{s}^{2}$$

is the second variant of the given predetermined type of probability distribution, associated with the second style code;

$${μ}_{s}^{2}$$

is the mean of the second variant of the given predetermined type of probability distribution; and

$${σ}_{s}^{2}$$

is the variance of the second variant of the given predetermined type of probability distribution.

To further train the generative stylization system 200, in some non-limiting embodiments of the present technology, the processor 110 can be configured to swap the motion content and style between respective motion feature vectors representative of different training motion sequences, such as z² and z³ mentioned above. More specifically, in these embodiments, the processor 110 can be configured to access a third content encoder 324, a third style encoder 326, and a third generator 328 for generating, based on the third motion feature vector z³, a third content code and a third style code associated with the third motion feature vector. Further, unlike in the previous cases, in some non-limiting embodiments of the present technology, the processor 110 can be configured to feed the second content code (generated by the second content encoder 314) and the third style code (generated by the third style encoder 326) to the third generator 328 to generate a transferred synthetic motion feature vector \hat{z}^{t}, which is believed to preserve the content information from z² and the style from z³. Similarly, each one of the third content encoder 324, the third style encoder 326, and the third generator 328 can be respective replicas of the first content encoder 304, the first style encoder 306, and the first generator 308.

Further, the processor 110 can be configured to access a fourth content encoder 334, a fourth style encoder 336, a fourth generator 338, and a fifth generator 348. Similarly, the fourth content encoder 334, the fourth style encoder 336 can be respective replicas of the first content encoder 304 and the first style encoder 306; and the fourth and fifth generators 338, 348 can be respective replicas of the first generator 308. Thus, using these components, the processor 110 can be configured to: (i) feed the transferred synthetic motion feature vector ît to the fourth content encoder 334 to generate a transferred content code; (ii) feed the transferred synthetic motion feature vector ît to the fourth style encoder 336 to generate a transferred style code.

Further, the processor 110 can be configured to swap the so generated content and style codes to generate respective synthetic motion feature vectors. More specifically, the processor 110 can be configured to: (i) feed the transferred content code along with the second style code (generated by the second style encoder 316) to the fourth generator 338 to generate a first intermediate synthetic motion feature vector \tilde{z}¹; and (ii) feed the third content code (generated by the third content encoder 324) along with the transferred style code to the fifth generator 348 to generate a second intermediate synthetic motion feature vector \tilde{z}².

Therefore, since the transferred content style of \hat{z}^{t} and the second style code of z² has been re-combined, the fourth generator 338 can now be trained to restore the second motion feature vector z². Similarly, in these embodiments, the fifth generator 348 can be trained to restore the third motion feature vector z³. To that end, the processor 110 can be configured to minimize a difference between outputs of the fourth and fifth generators 338, 348 and the second and third motion feature vectors, respectively. In some non-limiting embodiments of the present technology, for further training the generative stylization system 200 based on the swapped content and style codes, using the decoder 210 (not depicted in FIG. 3), the processor 110 can be configured to generate, based on the first and second intermediate synthetic motion feature vectors (respectively marked \tilde{z}² and \tilde{z}³ in FIG. 3), a first and second intermediate synthetic motion sequence, respectively, and further minimize a difference therebetween.

In some non-limiting embodiments of the present technology, to minimize the above differences, the processor 110 can be configured to minimize a cycle reconstruction loss function, defined by a following equation:

$${ℒ}_{cyc} = {\sum }_{i = 1}^{n} ‖ {\tilde{z}}^{i} - {z}^{i} ‖ + ‖ {\tilde{P}}^{i} - {P}^{i} ‖ , \qquad ( 3 )$$

where zⁱ is the respective training motion feature vector, such as one of the second and third motion feature vectors in the above example,
\tilde{z}ⁱ is a respective one of the first and second intermediate synthetic motion feature vectors generated by the fourth and fifth generators 338, 348, respectively;
Pⁱ is the given training motion sequence; and
\tilde{P}ⁱ is a respective one of the first and second intermediate synthetic motion sequences.

In some non-limiting embodiments of the present technology, to form smooth and sampleable style space for sampling style codes therefrom, in those embodiments where the given predetermined type of probability distribution is the normal probability distribution, the processor 110 can be configured to regularize all style spaces using a KL loss function:

$${ℒ}_{KL} = {\sum }_{i = 1}^{n} {D}_{KL} ( {𝒩}_{s}^{i} ( {μ}_{s}^{i} , {σ}_{s}^{i} ) ‖ 𝒩 ( 0 , 1 ) ) , \qquad ( 4 )$$

$$where {𝒩}_{s}^{i}$$

is the given one of the respective variant of the given predetermined type of probability distribution;

$${μ}_{s}^{i}$$

is a mean of the respective variant of the given predetermined type of probability distribution;

$${σ}_{s}^{i}$$

is a variance of the respective variant of the given predetermined type of probability distribution;
[symbol] (0, 1) is the standard normal probability distribution, that is the normal probability distribution having the mean being 0 and the variance being 1.

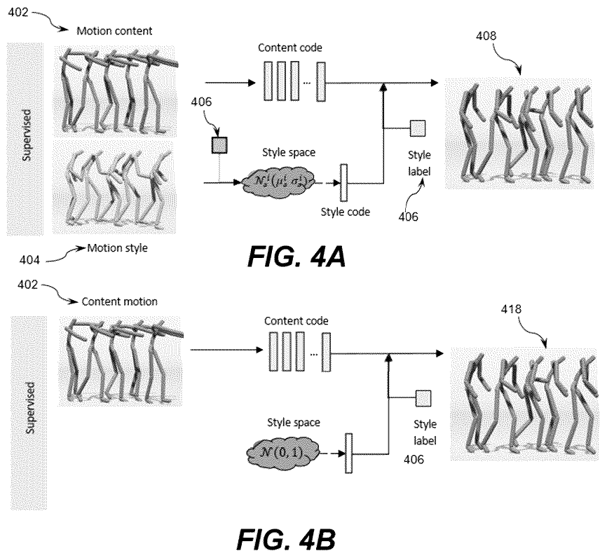

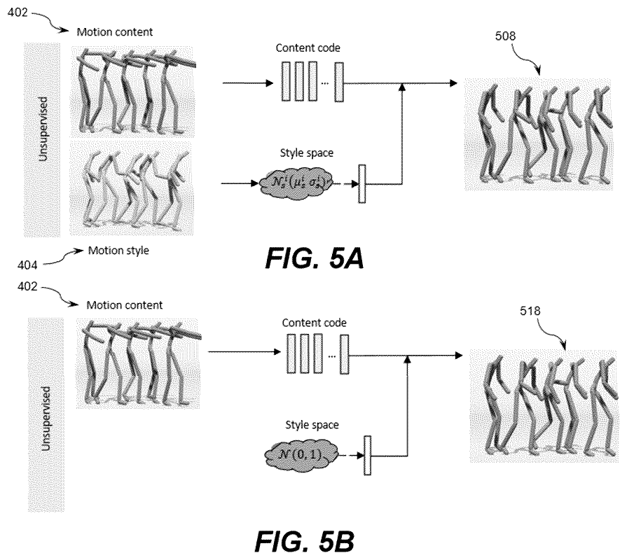

Overall, according to certain non-limiting embodiments of the present technology, to train the generative stylization system 200 to generate new in-use synthetic motion sequences (such as those depicted in FIGS. 4A to 4B and 5A to 5B), the processor 110 can be configured to jointly train the components of the generative stylization system 200, mentioned above with reference to FIG. 3, minimizing a total loss function comprising a combination (such as a summation) of the loss functions expressed by Equations (1, 2, 3, and 4), that is, [symbol] = [symbol] +λₕₛₐ [symbol] +λ_{cyc} [symbol] +λₖₗ [symbol] , for example, where λₕₛₐ, λ_{cyc} and λₖₗ are hyperparameters, which, for example, can be (1, 0.1, 0.1) and (0.1, 1, 0.01) for the supervised training and unsupervised training, respectively.

Further, according to certain non-limiting embodiments of the present technology, during the in-use phase, for determining a given in-use synthetic motion feature vector, such as one of first, second, third, and fourth synthetic motion feature vectors 408, 418, 508, and 518 of FIGS. 4A to 4B and 5A to 5B, based on which a respective in-use synthetic motion sequence can be determined, the processor 110 can be configured to use the second content encoder 314, the third style encoder 326, and the third generator 328, as will be described immediately below.

### In-Use Phase

First, with reference to FIGS. 4A to 4B, there are schematically depicted diagrams of the in-use phase for the embodiments where the generative stylization system 200 has been trained, by the processor 110, in a supervised manner, that is, using the respective style labels as mentioned above.

More specifically, in the embodiments illustrated in FIG. 4A, the processor 110 can be configured to: (i) receive, such as from a reference motion sequence submitted by a user, an in-use motion content 402 and an in-use motion style 404; (ii) an in-use style label 406 of a desired motion style to be generated; and (iii) feed these data to the generative stylization system 200 trained as described above, thereby causing the generative stylization system 200 to generate the first in-use synthetic motion feature vector 408. Further, the processor 110 can be configured to apply the decoder 210 to the first in-use synthetic motion feature vector 408 to generate a first in-use synthetic motion sequence (not separately labelled) of the given digital object.

Further, in the embodiments illustrated in FIG. 4B, the processor 110 can be configured to: (i) receive the in-use motion content 402; (ii) the in-use style label 406 of the desired motion style to be generated; and (iii) feed these data to the generative stylization system 200, thereby causing the generative stylization system 200 to generate the second in-use synthetic motion feature vector 418. In these embodiments, the in-use style code is generated non-deterministically, by sampling from the standard variant of the given predetermined type of probability distribution, such as the standard normal probability distribution. Further, the processor 110 can be configured to apply the decoder 210 to the second in-use synthetic motion feature vector 418 to generate a second in-use synthetic motion sequence (not separately labelled) of the given digital object.

Further, with reference to FIGS. 5A to 5B, there are schematically depicted diagrams of the in-use phase for the embodiments where the generative stylization system 200 has been trained, by the processor 110, in a unsupervised manner, that is, without using the respective style labels as mentioned above.

More specifically, in the embodiments illustrated in FIG. 5A, the processor 110 can be configured to: (i) receive the in-use motion content 402 and the in-use motion style 404; and (ii) feed these data to the generative stylization system 200 trained as described above, thereby causing the generative stylization system 200 to generate the third in-use synthetic motion feature vector 508. In these embodiments, akin to those illustrated in FIG. 4B, the processor 110 can be configured to sample the in-use style code for the third in-use synthetic motion feature vector 508 from the respective variant of the given predetermined type of probability distribution, parameters of which have been determined based on the reference motion sequence. Further, the processor 110 can be configured to apply the decoder 210 to the third in-use synthetic motion feature vector 508 to generate a third in-use synthetic motion sequence (not separately labelled) of the given digital object.

Finally, in the embodiments illustrated in FIG. 5B, the processor 110 can be configured to: (i) receive only the in-use motion content 402, and based thereon randomly sample from the standard variant of the given probability distribution, the style code of the desired motion style to be applied to the received motion sequence; and (ii) feed these data to the generative stylization system 200, thereby causing the generative stylization system 200 to generate the fourth in-use synthetic motion feature vector 518. Further, the processor 110 can be configured to apply the decoder 210 to the fourth in-use synthetic motion feature vector 518 to generate a fourth in-use synthetic motion sequence (not separately labelled) of the given digital object.

Thus, using the generated in-use synthetic motion sequences, the given digital object can further be animated.

### Computer-Implemented Method

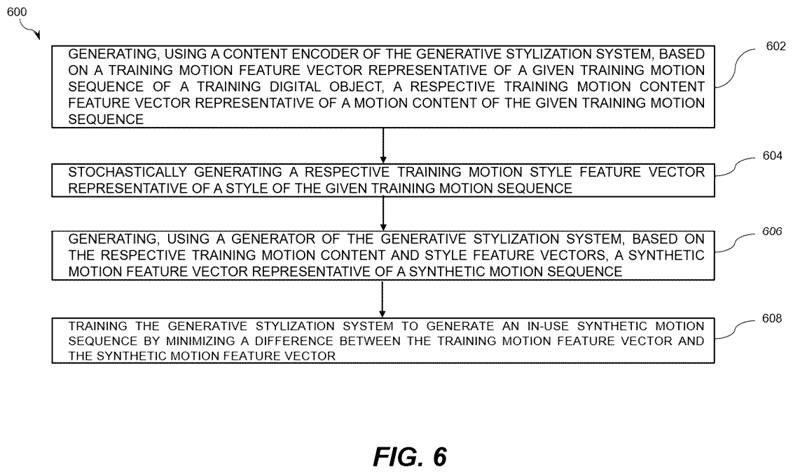

With reference to FIG. 6, there is depicted a flowchart diagram of a method 600 for training the generative stylization system 200 to generate motion sequences for animating digital objects, in accordance with certain non-limiting embodiments of the present technology. The method 600 can be executed by the processor 110 of the computing environment 100.

As noted hereinabove, the processor 110 can be configured to train the generative stylization system 200 based on training data including a plurality of training digital objects, a given one of which can include the given training motion sequence (similar to the given motion sequence 201). In some non-limiting embodiments of the present technology, where the processor applies a supervised training approach to the generative stylization system 200, the given training digital object can further include the respective style label representative of the motion style of the given training motion sequence.

Further, based on the given training motion sequence, using the encoder 202 mentioned above, the processor 110 can be configured to generate the respective training motion feature vector z, based on which the processor 110 can further be configured to train the generative stylization system 200, as will be described in the steps below.

Step 602: Generating, Using a Content Encoder of the Generative Stylization System, Based on a Training Motion Feature Vector Representative of a Given Training Motion Sequence of a Training Digital Object, a Respective Training Motion Content Feature Vector Representative of a Motion Content of the Given Training Motion Sequence

As explained in detail with reference to FIG. 3, the method 600 commences at step 602 with the processor 110 being configured to feed the first training motion feature vector (of a first training motion sequence) to the first content encoder 304 to generate the first content code representative of the motion content of the first training motion sequence.

The method 600 hence advances to step 604.

Step 604: Generating, Using a Style Encoder of the Generative Stylization System, Based on the Training Motion Feature Vector, a Plurality of Training Motion Style Feature Vectors for Randomly Selecting Therefrom a Respective Training Motion Style Feature Vector Representative of a Style of the Given Training Motion Sequence

At step 604, according to certain non-limiting embodiments of the present technology, the processor 110 can be configured to feed the first training motion feature vector to the first style encoder 306 to generate the first style code. As mentioned hereinabove, by using the first style encoder 306, the processor 110 can be configured to generate the first style code stochastically. More specifically, according to certain non-limiting embodiments of the present technology, by feeding the first training motion feature vector to the first style encoder 306, the processor 110 is configured to cause the first style encoder 306 to generate one or more parameters for the first variant of the given predetermined type of probability distribution, such as the mean and variance in case where the given predetermined type of probability distribution is the normal probability distribution. Further, the processor 110 can be configured to sample, from the first variant of the given predetermined type of probability distribution, the first style code. As the processor 110 can be configured to sample a plurality of different style codes from the first variant of the given predetermined type of probability distribution, the processor 110 can be said to randomly select the first style code from the plurality of different style codes as being representative of the motion style of the first training motion sequence.

As noted hereinabove, in some non-limiting embodiments of the present technology, the processor 110 can be configured to train the generative stylization system 200 by applying thereto the unsupervised training approach, that is without using the respective style label associated with the first training motion feature vector. However, in other non-limiting embodiments of the present technology, the processor 110 can be configured to train the generative stylization system 200 in the supervised manner. More specifically, in these embodiments, to generate the first style code, the processor 110 can be configured to feed, to the first style encoder 306, along with the first training motion feature vector, the respective style label associated therewith.

The method 600 hence advances to step 606.

### Step 606: Generating, Using a Generator of the Generative Stylization System, Based on the Respective Training Motion Content and Style Feature Vectors, a Synthetic Motion Feature Vector Representative of a Synthetic Motion Sequence

At step 606, the processor 110 can be configured to feed the first content conde and the first style code to the first generator 308, thereby causing the first generator 308 to generate the first synthetic motion feature vector z¹. In some non-limiting embodiments of the present technology, the processor 110 can be configured to feed the first synthetic motion feature vector \hat{z}ⁱ to the decoder 210 to restore the first synthetic motion sequence.

The method 600 hence advances to step 608

Step 608: Training the Generative Stylization System to Generate an in-Use Synthetic Motion Sequence by Minimizing a Difference Between the Training Motion Feature Vector and the Synthetic Motion Feature Vector

At step 608, to train the first generator 308 to generate synthetic motion feature vectors, the processor 110 can be configured to minimize a difference between the first training motion feature vector z¹ and the first synthetic motion feature vector \hat{z}¹. In some non-limiting embodiments of the present technology, the processor 110 can be configured to minimize the difference between the first training motion sequence and the first synthetic motion sequence, generated by the decoder 210 based on the first synthetic motion feature vector \hat{z}¹. In some non-limiting embodiments of the present technology, these differences can be defined by the value of the reconstruction loss function, expressed by Equation (1).

Further, in some non-limiting embodiments of the present technology, the processor 110 can be configured to further train the generative stylization system 200 to minimize the difference between the style spaces used for sampling style codes representative of similar motion styles. To that end, as described further above with reference to FIG. 3, the processor 110 can be configured to access the second style encoder 316 for generating the second style code based on the second training motion feature vector, which is representative of the second training motion sequence, similar in motion style to the first training motion sequence. Further, the processor 110 can be configured to minimize the difference between the first and second variants (defining the respective style spaces) of the given predetermined type of probability distributions, from which the first and second style codes have been sampled. To that end, in some non-limiting embodiments of the present technology, the processor 110 can be configured to minimize the value of the homo-style alignment loss function expressed by Equation (2).

In some non-limiting embodiments of the present technology, as described further above with reference to FIG. 3, the processor 110 can be configured to train the generative stylization system 200 to restore motion feature vectors based on swapped content and style codes. To that end, the processor 110 can be configured to access (1) the second, third, and fourth content encoders 314, 324, 334; (2) the third and fourth style encoders 326, 336; and (3) the third, fourth, and fifth generators 328, 338, 348.

More specifically, in these embodiments, first, the processor 110 can be configured to cause the third generator 328 to generate the transferred synthetic motion feature vector \hat{z}t based on (i) the second content code, generated by the second content encoder 314 based on the second training motion feature vector and (ii) the third style code, generated by the third style encoder 326 based on the third training motion feature vector. As mentioned above, the second and third training motion feature vector can be representative of respective training motion sequences that are different in motion style. Further, the processor 110 can be configured to swap the so generated content and style codes to generate respective synthetic motion feature vectors. More specifically, the processor 110 can be configured to: (i) feed the transferred content code along with the second style code (generated by the second style encoder 316) to the fourth generator 338 to generate a first intermediate synthetic motion feature vector \tilde{z}¹; and (ii) feed the third content code (generated by the third content encoder 324) along with the transferred style code to the fifth generator 348 to generate a second intermediate synthetic motion feature vector \tilde{z}².

Therefore, since the transferred content style of z^{t} and the second style code of z² has been re-combined, the fourth generator 338 can now be trained to restore the second motion feature vector z². Similarly, in these embodiments, the fifth generator 348 can be trained to restore the third motion feature vector z³. To that end, the processor 110 can be configured to minimize a difference between outputs of the fourth and fifth generators 338, 348 and the second and third motion feature vectors, respectively. In some non-limiting embodiments of the present technology, for further training the generative stylization system 200 based on the swapped content and style codes, using the decoder 210 (not depicted in FIG. 3), the processor 110 can be configured to generate, based on the first and second intermediate synthetic motion feature vectors (respectively marked 22 and 23 in FIG. 3), using the decoder 210, the first and second intermediate synthetic motion sequence, respectively, and further minimize a difference therebetween. To do so, the processor 110 can be configured to minimize the value of the cycle reconstruction loss function expressed by Equation (3).

In some non-limiting embodiments of the present technology, to form smooth and sampleable style space for sampling style codes therefrom, in those embodiments where the given predetermined type of probability distribution is the normal probability distribution, the processor 110 can be configured to regularize all style spaces using the KL loss function expressed by Equation (4).

Overall, according to certain non-limiting embodiments of the present technology, to train the generative stylization system 200 to generate new in-use synthetic motion sequences (such as those depicted in FIGS. 4A to 4B and 5A to 5B), the processor 110 can be configured jointly train the components of the generative stylization system 200, mentioned above with reference to FIG. 3, minimizing a value of the total loss function comprising a combination (such as a summation) of the loss functions expressed by Equations (1, 2, 3, and 4), that is, [symbol] = [symbol] +λ^{hsa} [symbol] +λ_{cyc} [symbol] +λₖₗ [symbol] .

Further, according to certain non-limiting embodiments of the present technology, during the in-use phase, for determining the given in-use synthetic motion feature vector, based on which the respective in-use synthetic motion sequence can be determined, the processor 110 can be configured to use the second content encoder 314, the third style encoder 326, and the third generator 328, as described above with reference to FIGS. 4A to 4B and 5A to 5B with respect to the first, second, third, and fourth synthetic motion feature vectors 408, 418, 508, and 518.

The method 600 hence terminates.

Thus, certain non-limiting embodiments of the method 600 may allow training the generative stylization system 200 to generate motion styles non-deterministically, which may further allow generating the synthetic motion sequences that would be perceived as being more natural, improving, for example, user experience of users of applications where the so generated synthetic motion sequences are employed for animating digital objects, such as characters of cartoons or video games, and the like.

### Experiments and Results

### Datasets

For the conducted experiments, the generative stylization model 200 was trained, as described above, based on the training data described in an article “Unpaired motion style transfer from video to animation” by Aberman et al. These training data contain 16 distinct style labels including angry, happy, old, etc. The total duration of the training motion sequences of Aberman et al. was around 193 minutes. During a testing phase, two other training datasets to evaluate the generalization ability were used. A first training dataset was that described in an article “Realtime style transfer for unlabeled heterogeneous human motion” by Xia et al. and was a relatively smaller motion style collection that included 8 styles, with accurate action type annotations (8 actions). A second training dataset one was from Carnegie-mellon Mocap (CMU Mocap) database that included an unlabeled training dataset with high diversity and quantity of motion data. All motion data is retargeted to a same 21-joint skeleton structure, with a 10% held-out subset for evaluation.

Further, for pose processing and augmentation, an approach described in “Generating diverse and natural 3d human motions from text” by Guo et al. was used. Briefly, according to this approach, a single pose is represented by a tuple of root angular velocity, root linear velocity, root height, local joint positions, velocities, 6D rotations and foot contact labels, resulting in 260-D pose representation. Meanwhile, all data is downsampled to 30 FPS, augmented by mirroring, and applied with Z-nomalization. For training on the training dataset provided in Aberman et al., input motions are uniformly trimmed to 160 poses (~5.3s). During evaluation, styles were all from Aberman et al., while motion contents were from one of the three test sets. For real applications, the motion contents can have arbitrary length.

### Metrics, Baselines and Implementation

A comprehensive collection of metrics were used for evaluation of the generative stylization system 200. First, a style classifier was pre-trained based on the above-described training data, and further used as a style feature extractor to compute style recognition accuracy and style FID. For dataset with available action annotation (Xia et al.), an action classifier was trained to extract content features and calculate content recognition accuracy and content Fréchet Inception Distance (FID). Further, the content preservation was evaluated using geodesic distance of the local joint rotations between input motion content and generated motion. Diversity was also employed to quantify the stochasticity in the stylization results of same content and style input, as described in an article “Dancing to music” by Lee et al.

Regarding the used baselines, the present method was compared to three state-of-the-art methods, including: (i) a first approach described in Aberman et al.; (ii) a second approach described in an article “Diverse motion stylization for multiple style domains via spatial-temporal graph-based generative model” by Park et al., which are supervised approaches learned within a GAN framework; and (iii) a third approach described in an article “Motion puzzle: Arbitrary motion style transfer by body part” by Jang et al. which is an unsupervised approach that takes motion style for deterministic stylization. To compare with them, these baseline models were re-trained using their official implementation, with minimal modification for unifying motion FPS, length and representation.

In some non-limiting embodiments of the present technology, the generative stylization system 200 can be developed in Pytorch. The encoder 202 and the decoder 210 can be implemented as a 1-D convolution layers. The content encoder 204, E_{c}, and the style encoder 206, Eₛ, can also be implemented as downsampling convolutional networks, where the style encoder 206 includes an average pooling layer before an output dense layer.

### Quantitative Results

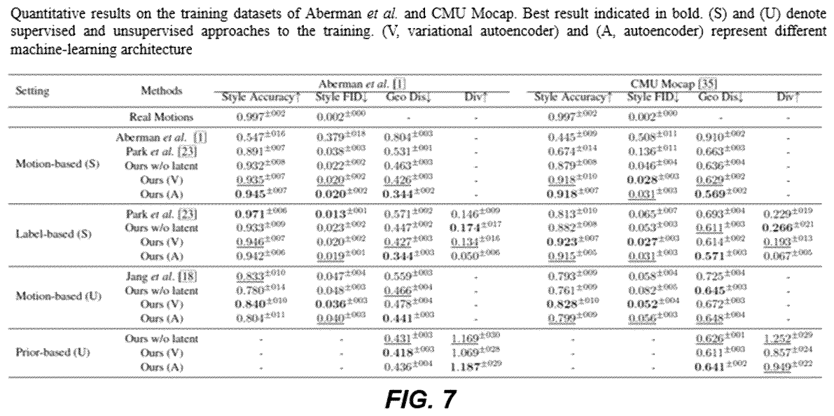

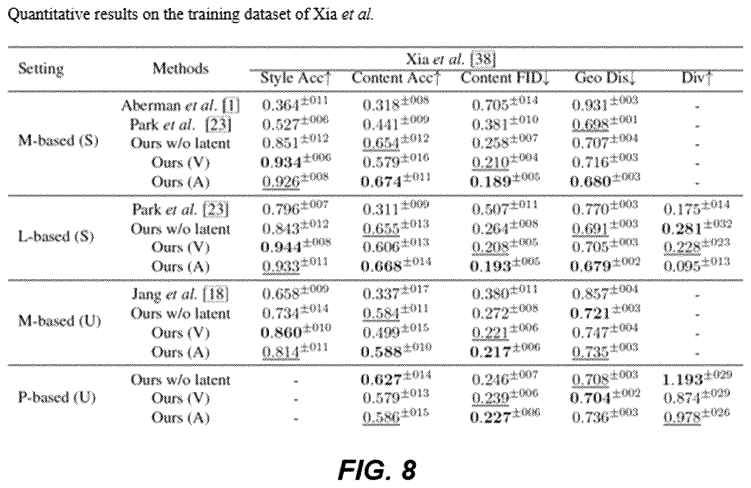

FIGS. 7 and 8 depict tables that are reflective of quantitative evaluation results of the generative stylization system 200 trained based on the training datasets of Aberman et al., CMU Mocap, and Xia et al.; the two latter datasets were completely unseen to the generative stylization system 200 during the training phase. The generative stylization system 200 was used to generate results using motions in these three sets as content, and randomly sampling motion styles and labels from the Aberman et al. For adequate comparison, this experiment was repeated 30 times, after which the mean value with a 95% confidence interval was taken. Also, there was considered an embodiment of the present method with non-latent stylization, using a variational autoencoder as a motion latent model. Overall, the methods described herein allow consistently achieving appealing performance on a variety of applications across all the three datasets. It was demonstrated that in the supervised setting, GAN approaches, such as those of Aberman et al. and Park et al., tend to overfit on one dataset and find difficult on scaling to other domains. For example, Park et al. earns the highest achievement on style recognition on the training datasets of Aberman et al., as 97.1%, while underperforms on the other two unseen datasets, with style accuracy of 81.3% and 79.6%, respectively. Furthermore, these approaches usually fall short in preserving content, as evidenced by the low content accuracy (31.8% and 44.1%) in the table of FIG. 8. The third approach described in Jang et al. was shown to be a competitive unsupervised baseline; it appears to gain comparable and stable results on different datasets, which, however, still suffers from content preservation. By contrast, the supervised and unsupervised approaches to training the generative stylization system 200 described herein demonstrated high style accuracy over 90% and 80% respectively, with minimal loss on content semantics. Among all variants, the present methods and systems appear to improve the performance on almost all aspects, including generalization ability, with slight compromise on diversity.

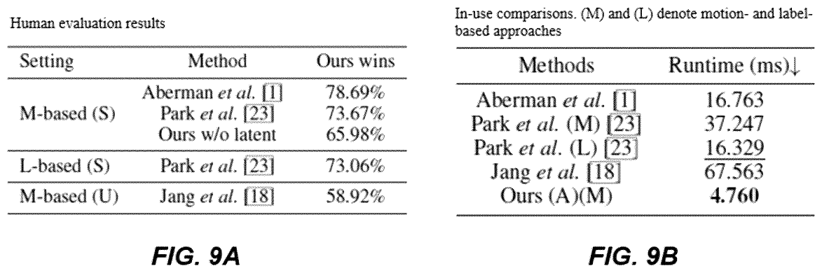

In addition, a user study on Amazon™ Mechanical Turk™ was conducted to perceptually evaluate our motion stylization results. 50 comparison pairs on CMU Mocap training dataset between each baseline model and the present method (in each setting) were generated and shown to 4 users, who were asked to choose their favored one with respect to realism and stylization quality. Overall, we collect 992 responses from 27 AMT users with master recognition. As shown in a table of FIG. 9A, the present method earned more user appreciation than most of the baselines by a large margin. In the unsupervised setting, the present method also slightly outperformed the state-of-the-art approach of Jang et al., which consisted of heavily designed multi-scale skeleton-based G.

Further, a table of FIG. 9B presents the comparisons of average time cost for a single forward pass with 160-frame motion inputs, evaluated on a single Tesla P100 16G GPU. The prior approaches apply style injection at each generator layers until the motion output, and usually involve computationally intensive operations such as graph up-pooling and forward-loop kinematics. Benefiting from the present latent stylization and simple yet effective network design, the generative stylization system 200 described herein appears to be much faster and shows the potential for real time applications.

### Qualitative Results

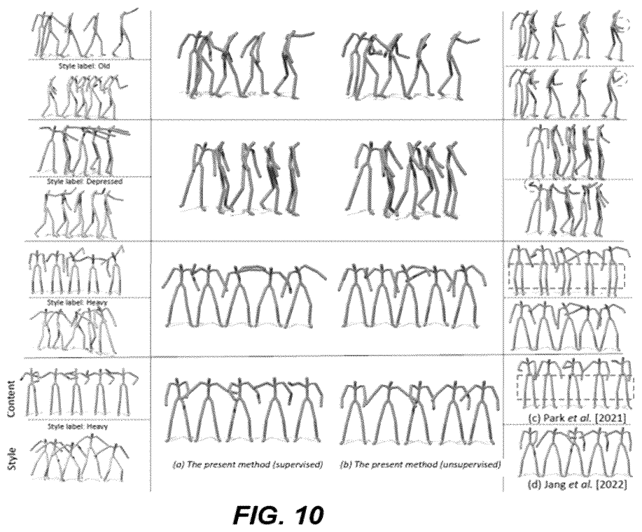

With reference to FIG. 10, there is schematically depicted visual comparison between results on the training datasets of Aberman et al. (top two) and CMU Mocap (bottom two), in supervised (the present method vs. the approach of Park et al.) and unsupervised (the present method vs. the approach of Jang et al.) settings. In the unsupervised setting, the approach of Jang et al. had comparable performance on transferring style from a motion style to a motion content; but it sometimes changes the actions from the motion content, as indicated by circles. Supervised baseline follows similar trend. Moreover, the results of Park et al. on the CMU Mocap training dataset appear to fail to capture the style information from the input motion style. This also aligns with the observation of Park et al.'s limited generalization ability, as illustrated by the data in the table of FIG. 7 depicted. In contrast, the present method showed reliable performance on both maintaining content semantics and capturing style characteristics for robust stylization.

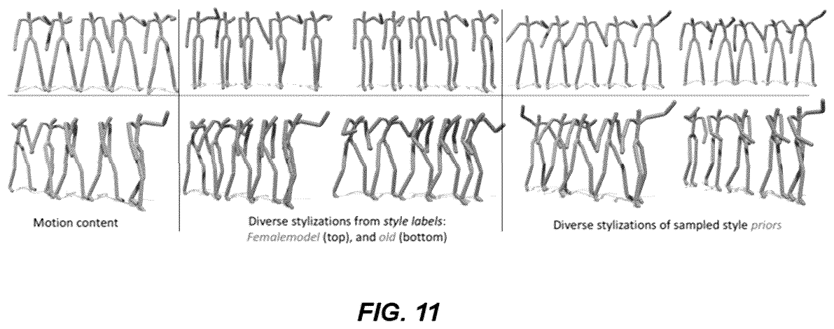

Further, the present method showed diversity for label-based and prior-based stylization (that is, with the style code being sampled from a prior probability distribution). As illustrated in FIG. 11, for label-based stylization, taken one motion content and style label as input, the generative stylization system 200 is able to generate multiple stylized results with inner-class variations, for example, different manners of old man walking.

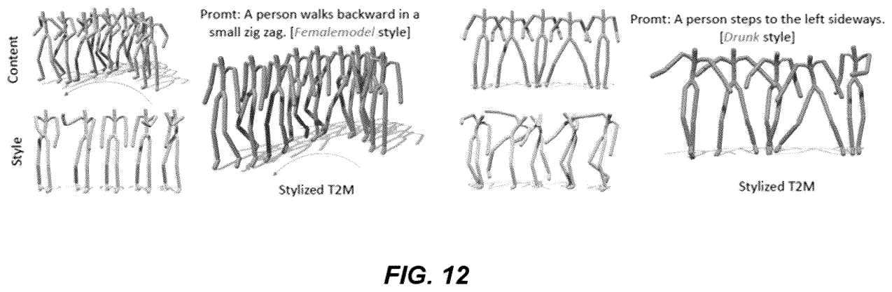

Further, with reference to FIG. 12, there was demonstrated feasibility of generating desired human motions from the text and style prompt, by simply plugging the generative stylization system 200 behind an off-the-shelf text-to-motion generator (such as that described in Guo et al. mentioned above).

Modifications and improvements to the above-described implementations of the present technology may become apparent to those skilled in the art. The foregoing description is intended to be exemplary rather than limiting. The scope of the present technology is therefore intended to be limited solely by the scope of the appended claims.

1. A computer-implemented method for training a generative stylization system to generate motion sequences for digital objects, the method comprising:
generating, using a content encoder of the generative stylization system, based on a training motion feature vector representative of a given training motion sequence of a training digital object, a respective training motion content feature vector representative of a motion content of the given training motion sequence;
stochastically generating a respective training motion style feature vector representative of a style of the given training motion sequence, the stochastically generating comprising:
generating, using a style encoder of the generative stylization system, based on the training motion feature vector, one or more parameters for a given variant of a given predetermined type of probability distribution; and
sampling the respective training motion style feature vector from the given variant of the given predetermined type of probability distribution;
generating, using a generator of the generative stylization system, based on the respective training motion content and style feature vectors, a synthetic motion feature vector representative of a synthetic motion sequence; and
training the generative stylization system to generate an in-use synthetic motion sequence by minimizing a difference between the training motion feature vector and the synthetic motion feature vector.

2. The method of claim 1, wherein:
the given predetermined type of probability distribution is a normal distribution; and
the one or more parameters include at least a mean and a variance of the normal distribution.

3. The method of claim 1, wherein:
the stochastically generating comprises feeding the training motion feature vector to the style encoder,
prior to the stochastically generating the respective training motion style feature vector, the method further comprises receiving a training style label for the given training sequence motion sequence; and
wherein the stochastically generating the respective training motion style feature vector further comprises feeding the training style label to the style encoder.

4. The method of claim 1, wherein the method further comprises determining, based on the synthetic motion feature vector, the respective synthetic training motion sequence; and
wherein the minimizing the difference comprises minimizing a difference between at least one of: (i) the respective motion feature vector and the synthetic motion feature vector; and (ii) the given training motion sequence and the respective synthetic training motion sequence.

5. The method of claim 4, wherein the minimizing the difference comprises minimizing a value of a reconstruction loss function, defined by a following equation:
$${ℒ}_{rec} = {\sum }_{i = 1}^{n} ‖ {\hat{z}}^{i} - {z}^{i} ‖ + ‖ {\hat{P}}^{i} - {P}^{i} ‖ ,$$
where zⁱ is the training motion feature vector;
\hat{z}ⁱ is the respective synthetic training motion feature vector at a respective iteration of the training the generator,
Pⁱ is the given training motion sequence; and
\hat{P}ⁱ is the respective synthetic training motion sequence determined based on the synthetic training motion feature vector.

6. The method of claim 1, wherein:
the stochastically generating comprises generating, using the style encoder, based on the training motion feature vector, one or more parameters for a first variant of the given predetermined type of probability distribution; and
wherein the training the generative stylization system further comprises:
accessing a second style encoder, the second style encoder being a replica of the style encoder,
generating, using the second style encoder, based on a second training motion feature vector representative of a second training motion sequence of the training digital object, one or more parameters for a second variant of the given predetermined type of probability distribution,
the given training motion sequence and the second training motion sequence being motion subsequences of a single training motion sequence of the training digital object; and
minimizing a difference between the first and second variants of the given predetermined type of probability distribution.

7. The method of claim 6, wherein:
the given predetermined type of probability distribution comprises a normal distribution; and
the minimizing the difference between the first and second variants of the given predetermined type of probability distribution comprises minimizing a value of a homo-style alignment loss function, defined by a following equation:
$${ℒ}_{hsa} = {D}_{KL} ( {𝒩}_{s}^{1} ( {μ}_{s}^{1} , {σ}_{s}^{1} ) ‖ {𝒩}_{s}^{2} ( {μ}_{s}^{2} , {σ}_{s}^{2} ) ) ,$$
$$where {𝒩}_{s}^{1}$$
is the first variant of the given predetermined type of probability distribution;
$${μ}_{s}^{1}$$
is a mean of the first variant of the given predetermined type of probability distribution;
$${σ}_{s}^{1}$$
is a variance of the first variant of the given predetermined type of probability distribution;
$${𝒩}_{s}^{2}$$
is the second variant of the given predetermined type of probability distribution;
$${μ}_{s}^{2}$$
is the mean of the second variant of the given predetermined type of probability distribution; and
$${σ}_{s}^{2}$$
is thee variance of th second variant of the given predetermined type of probability distribution.

8. The method of claim 1, wherein prior to the training, the method further comprises:
accessing: (i) a second style encoder, and (ii) a second generator,
the second style encoder being a replica of the style encoder, and
the second generator being a replica of the generator,
stochastically generating, using the second style encoder, based on the synthetic motion feature vector, a respective synthetic motion style feature vector representative of the style of the respective synthetic training motion sequence;
causing the second generator to generate, based on (1) the respective training motion content feature vector and (2) respective synthetic motion style feature vector, a first intermediate synthetic motion feature vector; and
wherein the training further comprises minimizing a first difference between the training motion feature vector and the first intermediate synthetic motion feature vector.

9. The method of claim 8, wherein prior to the training, the method further comprises:
accessing: (i) a second content encoder, and (ii) a third generator,
the second content encoder being a replica of the content encoder, and
the third generator being a replica of the generator,
generating, using the second content encoder, based on the synthetic motion feature vector, a respective synthetic motion content feature vector representative of the motion content of the respective synthetic training motion sequence;
causing the third generator to generate, based on (1) the respective synthetic motion content feature vector and (2) respective training motion style feature vector, a second intermediate synthetic motion feature vector; and
wherein the training further comprises minimizing a second difference between the training motion feature vector and the second intermediate synthetic motion feature vector.

10. The method of claim 9, wherein prior to the training, the method further comprises:
accessing a third style encoder and a fourth style encoder, the third and fourth style encoder being replicas of the style encoder,
stochastically generating, using the third style encoder, based on a first training motion feature vector representative of a first training motion sequence of the training digital object, one or more parameters for a first variant of the given predetermined type of probability distribution;
stochastically generating, using the fourth style encoder, based on a second training motion feature vector representative of a second training motion sequence of the training digital object, one or more parameters for a second variant of the given predetermined type of probability distribution;
the first and second training motion sequences being motion subsequences of an other training motion sequence, different from the given training motion sequence; and
wherein the training further comprises minimizing a difference between the first and second variants of the given predetermined type of probability distribution.

11. A system for training a generative stylization system to generate motion sequences for digital objects, the system comprising at least one processor and at least one non-transitory computer-readable medium comprising executable instructions, which, when executed by the at least one processor, cause the system to:
generate, using a content encoder of the generative stylization system, based on a training motion feature vector representative of a given training motion sequence of a training digital object, a respective training motion content feature vector representative of a motion content of the given training motion sequence;
stochastically generate a respective training motion style feature vector representative of a style of the given training motion sequence, by:
generating, using a style encoder of the generative stylization system, based on the training motion feature vector, one or more parameters for a given variant of a given predetermined type of probability distribution; and
sampling the respective training motion style feature vector from the given variant of the given predetermined type of probability distribution;
generate, using a generator of the generative stylization system, based on the respective training motion content and style feature vectors, a synthetic motion feature vector representative of a synthetic motion sequence; and
train the generative stylization system to generate an in-use synthetic motion sequence by minimizing a difference between the respective motion feature vector and the synthetic motion feature vector thereby.

12. The system of claim 11, wherein:
the given predetermined type of probability distribution is a normal distribution; and
the one or more parameters include at least a mean and a variance of the normal distribution.

13. The system of claim 11, wherein
to stochastically generate the respective training motion style feature vector, the at least one processor causes the system to feed the training motion feature vector to the style encoder;
prior to generating the respective training motion style feature vector, the at least one processor causes the system to receive a training style label for the given training sequence motion sequence; and
wherein to generate the respective training motion style feature vector, the at least one processor further causes the system to feed the training style label to the style encoder.

14. The system of claim 11, wherein the at least one processor further causes the system to determine, based on the synthetic motion feature vector, the respective synthetic training motion sequence; and
wherein to minimize the difference, the at least one processor causes the system to minimize a difference between at least one of: (i) the respective motion feature vector and the synthetic motion feature vector, and (ii) the given training motion sequence and the respective synthetic training motion sequence.

15. The system of claim 14, wherein to minimize the difference, the at least one processor causes the system to minimize a value of a reconstruction loss function, defined by a following equation:
$${ℒ}_{rec} = {\sum }_{i = 1}^{n} ‖ {\hat{z}}^{i} - {z}^{i} ‖ + ‖ {\hat{P}}^{i} - {P}^{i} ‖ ,$$
where zⁱ is the training motion feature vector;
\hat{z}ⁱ is the respective synthetic training motion feature vector at a respective iteration of the training the generator,
Pⁱ is the given training motion sequence; and
\hat{P}ⁱ is the respective synthetic training motion sequence determined based on the synthetic training motion feature vector.

16. The system of claim 11, wherein:
to stochastically generate the respective training motion style feature vector, the at least one processor causes the system to generate, using the style encoder, based on the training motion feature vector, one or more parameters for a first variant of the given predetermined type of probability distribution; and
wherein to train the generative stylization system, the at least one processor further causes the system to:
access a second style encoder, the second style encoder being a replica of the style encoder, stochastically generate, using the second style encoder, based on a second training motion feature vector representative of a second training motion sequence of the training digital object, one or more parameters for a second variant of the given predetermined type of probability distribution,
the given training motion sequence and the second training motion sequence being motion subsequences of a single training motion sequence of the training digital object; and
minimize a difference between the first and second variants of the given predetermined type of probability distribution.

17. The system of claim 16, wherein:
the given predetermined type of probability distribution comprises a normal distribution; and
to minimize the difference between the first and second variants of the given predetermined type of probability distribution, the at least one processor causes the system to minimize a value of a homo-style alignment loss function, defined by a following equation:
$${ℒ}_{hsa} = {D}_{KL} ( {𝒩}_{s}^{1} ( {μ}_{s}^{1} , {σ}_{s}^{1} ) ‖ {𝒩}_{s}^{2} ( {μ}_{s}^{2} , {σ}_{s}^{2} ) ) ,$$
$$where {𝒩}_{s}^{1}$$
is the first variant of the given predetermined type of probability distribution;
$${μ}_{s}^{1}$$
is a mean of the first variant of the given predetermined type of probability distribution;
$${σ}_{s}^{1}$$
is a variance of the first variant of the given predetermined type of probability distribution;
$${𝒩}_{s}^{2}$$
is the second variant of the given predetermined type of probability distribution;
$${μ}_{s}^{2}$$
is the mean of the second variant of the given predetermined type of probability distribution; and
$${σ}_{s}^{2}$$
is the variance of the second variant of the given predetermined type of probability distribution.

18. The system of claim 11, wherein, prior to training, the at least one processor further causes the system to:
access: (i) a second style encoder, and (ii) a second generator,
the second style encoder being a replica of the style encoder, and
the second generator being a replica of the generator,
stochastically generate, using the second style encoder, based on the synthetic motion feature vector, a respective synthetic motion style feature vector representative of the style of the respective synthetic training motion sequence;
cause the second generator to generate, based on (1) the respective training motion content feature vector and (2) respective synthetic motion style feature vector, a first intermediate synthetic motion feature vector; and
wherein to train the generative stylization system, the at least one processor further causes the system to minimize a first difference between the training motion feature vector and the first intermediate synthetic motion feature vector.

19. The system of claim 18, wherein prior to training, the at least one processor further causes the system to:
access: (i) a second content encoder, and (ii) a third generator,
the second content encoder being a replica of the content encoder, and
the third generator being a replica of the generator;
generate, using the second content encoder, based on the synthetic motion feature vector, a respective synthetic motion content feature vector representative of the motion content of the respective synthetic training motion sequence;
cause the third generator to generate, based on (1) the respective synthetic motion content feature vector and (2) respective training motion style feature vector, a second intermediate synthetic motion feature vector; and
wherein to train the generative stylization system, the at least one processor further causes the system to minimize a second difference between the training motion feature vector and the second intermediate synthetic motion feature vector.

20. A non-transitory computer readable medium for storing computer-executable instructions that, when executed, cause a computer system to perform a computer-implemented method for training a generative stylization system to generate motion sequences for digital objects, comprising:
generating, using a content encoder of the generative stylization system, based on a training motion feature vector representative of a given training motion sequence of a training digital object, a respective training motion content feature vector representative of a motion content of the given training motion sequence;
stochastically generating a respective training motion style feature vector representative of a style of the given training motion sequence, the stochastically generating comprising:
generating, using a style encoder of the generative stylization system, based on the training motion feature vector, one or more parameters for a given variant of a given predetermined type of probability distribution; and
sampling the respective training motion style feature vector from the given variant of the given predetermined type of probability distribution;
generating, using a generator of the generative stylization system, based on the respective training motion content and style feature vectors, a synthetic motion feature vector representative of a synthetic motion sequence; and
training the generative stylization system to generate an in-use synthetic motion sequence by minimizing a difference between the training motion feature vector and the synthetic motion feature vector.
